(19) United States
(12) Patent Application Publication
(10) Pub. No.: US 2011/0142402 A1
(43) Pub. Date: Jun. 16, 2011

(54) OPTICAL FIBER AND METHOD OF MANUFACTURING THE SAME, END PART PROCESSING METHOD OF OPTICAL FIBER AND OPTICAL FIBER WITH FERRULE

(75) Inventors: Masao TACHIKURA, Hitachi (JP); Kazumasa OHSONO, Hitachi (JP); Noribumi SHIINA, Hitachi (JP); Yoshikazu NAMEKAWA, Hitachi (JP)

(73) Assignee: HITACHI CABLE, LTD., Tokyo (JP)

(21) Appl. No.: 12/966,591

(22) Filed: Dec. 13, 2010

(30) Foreign Application Priority Data
Dec. 14, 2009 (JP) 2009-282564

(51) Int. Cl. G02B 6/255; G02B 6/38

(52) U.S. Cl. 385/96; 264/1.25

(57) ABSTRACT

An optical fiber that permits, even when the cladding outer diameter thereof is smaller than 125 μm, an eased splicing with other optical fiber using a general-purpose ferrule, is provided. The optical fiber comprises: a first optical fiber having a first core and a first cladding having a cladding outer diameter smaller than 125 μm, wherein the first cladding has a plurality of air holes that extend longitudinally along the axis of the first core; a second optical fiber having a second core to be spliced to the first core, and a second cladding having a cladding outer diameter larger than the outer diameter of the first cladding, wherein the second cladding is to be spliced to the first cladding; and a fusion splice formed between the end of the first optical fiber and the end of the second optical fiber by fusion.

### TECHNICAL FIELD

The present invention relates to an optical fiber and a method of manufacturing the same, and an end part processing method of an optical fiber, and an optical fiber with a ferrule; the invention particularly relates to an optical fiber, which is suitable for such as an optical fiber cord for communication and an optical device, and a method of manufacturing the same, and an end part processing method of an optical fiber, and an optical fiber with a ferrule.

### BACKGROUND OF THE INVENTION

In recent years, new types of optical fibers, called holey fibers (HFs) and photonic crystal fibers (PCFs), have attracted attention. (See Non-patent Literature 1 for example.)

A typical construction of holey fibers is illustrated in FIG. 7. As illustrated in FIG. 7, a holey fiber 102 is comprised of a core 121 and cladding 122 formed around the core 121, wherein the cladding 122 has a plurality of air holes 123 that extends longitudinally along the axis of the core 121.

An optical fiber of this kind including the holey fiber has such a characteristic that light does not leak easily even if the fiber is bent in a small curvature radius and, therefore, that the transmission loss (the bending loss) caused by bending is suppressed to low. Because of this advantage, applications of such fiber to the optical wiring in a customer premises and to the interconnections among various units of customer premises equipment have been under study in the field of Fiber to the Home (FTTH) technology.

To increase the tolerability against fiber break that occurs when a fiber is bent in a smaller-radius, there is a known technique that an optical fiber of this kind, which commonly has an outer diameter of 125 μm (the outer diameter of cladding), is made to have a smaller outer diameter than that (that is, 80 μm or less for example). (Refer to Patent Literatures 1 and 2.) Another advantage of making the outer diameter of an optical fiber small includes a reduction of manufacturing costs being feasible because of downsizing in the outer diameter.

Patent Literature 2 has described an optical connector having such a structure that a microstructure optical fiber is spliced to a conventional type of optical fiber having an outer diameter equal to that of the microstructure optical fiber by fusion or adhesion. By using an optical connector having such a configuration, the art defined in Patent Literature 2 enhances reliability of both an optical fiber and the optical connector preventing ingress of contaminating matters, such as polishing chip and polishing agent involved in the polishing process and water in the atmosphere in which the optical connector is used, into the microstructure optical fiber.

Patent Literature 3 has described a low loss splicing method, wherein a photonic crystal fiber, which has pores in its clad part in a manner similar to a holey fiber and offers a low bending loss, is spliced with a low connection loss to a conventional single-mode fiber (SMF, or monomode fiber) having the same outer diameter as the outer diameter of the photonic crystal fiber.

As regards the holey fiber stated above, Patent Literatures 4 to 6 also describe a method, wherein an optical fiber having an outer diameter almost same as the outer diameter of a holy fiber is fusion-spliced after sealing the pores in the end area of the holey fiber, or is fusion-spliced to seal such pores.

{Patent Literature 1}
Publication of Unexamined Japanese Patent Application, No. 2003-307632

{Patent Literature 2}
Publication of Unexamined Japanese Patent Application, No. 2004-220026

{Patent Literature 3}
Publication of Unexamined Japanese Patent Application, No. 2006-350308

{Patent Literature 4}
Publication of Unexamined Japanese Patent Application, No. 2005-24847

{Patent Literature 5}
Publication of Unexamined Japanese Patent Application, No. 2003-167145

{Patent Literature 6}
Publication of Unexamined Japanese Patent Application, No. 2007-272053

{Non-Patent Literature 1}
HASEGAWA Takemi: “Recent advances in photonic crystal fibers and holey fibers” Monthly OPTRONICS No. 7 pp. 203-208 (2001), The Optronics Co., Ltd.

### SUMMARY OF THE INVENTION

In connecting an optical fiber such as a holey fiber with its end installed with an optical connector to other optical fiber, a ferrule is usually installed on the end of the optical fiber. When this practice uses an optical fiber having such a cladding outer diameter smaller than 125 μm as is described in Patent Literatures 1 and 2, a special ferrule is employed as a commonly known technique. The special ferrule in this technique has such an insertion hole for inserting the optical fiber as is given an inner diameter smaller than that of a conventional ferrule in consistency with the cladding outer diameter of the optical fiber to be used.

However, the special ferrule like that having a small sized inner diameter of the insertion hole for inserting the optical fiber has problems in a practical use because such a ferrule is not an easily-workable item and incurs a higher manufacturing cost. This brings a concern that application of optical fibers, such as holey fibers, having a cladding outer diameter smaller than 125 μm to a wiring system in the subscriber premises or the inside of equipment may be disturbed.

On the other hand, a study is ongoing on an attempt at applying a jacket over a bare optical fiber, such as a holey fiber, having a cladding outer diameter smaller than 125 μm to a thickness that will provide an outer diameter of 125 μm to enable installation of a general-purpose ferrule used for optical fibers, such as SMF, having a cladding outer diameter of about 125±1 μm on the end of such optical fiber. However, applying a jacket over an optical fiber of which cladding outer diameter is smaller than 125 μm precisely without eccentricity of wall thickness of the jacket to obtain an optical fiber having an outer diameter of 125 μm requires a highly sophisticated manufacturing technique and invites a problem of cost increase in manufacturing. Further, when the jacket wall thickness is not uniform, there arises a concern that splice loss may increase, because such irregularity at the joining point with other optical fiber will cause deviation of the optical axis.

From the viewpoint of above-stated problems, a purpose of the present invention is to provide an optical fiber that permits, even when the cladding outer diameter thereof is smaller than 125 μm, an eased splicing with other optical fiber using a general-purpose ferrule without relying on such a special ferrule as has an insertion hole for inserting an optical fiber (a fiber insertion hole) having a reduced inner diameter and a method of manufacturing the same; an end part processing method of an optical fiber; and an optical fiber with a ferrule.

### MEANS FOR SOLVING THE PROBLEMS

To solve the above-stated problems, the present invention provides an optical fiber comprising:

a first optical fiber having a first core and a first cladding formed around the first core having a cladding outer diameter smaller than 125 μm, wherein the first cladding has a plurality of air holes that extend longitudinally along the axis of the first core;

a second optical fiber having a second core to be spliced to the first core and a second cladding formed around the second core having a cladding outer diameter larger than the outer diameter of the first cladding, wherein the second cladding is to be spliced to the first cladding; and

a fusion splice formed between the end of the first optical fiber and the end of the second optical fiber by fusion.

The present invention includes an improvement invention or a modification invention of the optical fiber by the present invention to solve above-stated problems as described below.

(1) The fusion splice has a tapered shape in the outer diameter transition, wherein the outer diameter of the fusion splice gradually reduces from the second optical fiber to the first optical fiber.

(2) The outer diameter of the first cladding of the first optical fiber is 100 μm or smaller and the outer diameter of the second cladding of the second optical fiber is 125±1 μm.

(3) The plurality of air holes are sealed at the fusion splice with the second optical fiber.

To solve the above-stated problems, the present invention further provides a method of manufacturing an optical fiber having such a configuration that

the end of a first optical fiber having a first core and a first cladding formed around the first core having a cladding outer diameter smaller than 125 μm, wherein the first cladding has a plurality of air holes that extends longitudinally along the axis of the first core, is spliced to

the end of a second optical fiber having a second core to be spliced to the first core and a second cladding formed around the second core having a cladding outer diameter larger than the outer diameter of the first cladding, wherein the second cladding is to be spliced to the first cladding, wherein

the method of manufacturing the optical fiber is comprised of the steps of

butting ends of the first optical fiber and the second optical fiber aligning optical axes of the first core and the second core; and

splicing by fusing the butted ends of the first optical fiber and the second optical fiber to form a fusion splice.

The present invention includes an improvement invention or a modification invention of the method of manufacturing an optical fiber by the present invention to solve above-stated problems as described below.

(1) The step of butting ends of the first optical fiber and the second optical fiber is such a process that the optical axes of the first core and the second core are aligned by positioning the first optical fiber and the second optical fiber so that the center of the first core determined by the position of the diametrical profile of the first cladding and the center of the second core determined by the position of the diametrical profile of the second cladding will align on one common axis.

(2) The step of splicing by fusing the butted ends of the first optical fiber and the second optical fiber to form a fusion splice is such a process that the fusion splice is formed so that the fused splice thereon will have a tapered shape in terms of the outer diameter, wherein the outer diameter of the fusion splice gradually reduces to the first optical fiber from the second optical fiber.

(3) The step of splicing by fusing the butted ends of the first optical fiber and the second optical fiber to form a fusion splice is such a process that the splice is formed so that the plurality of air holes will be sealed by the second optical fiber at the fusion splice.

To solve the above-stated problems, the present invention further provides an end part processing method of an optical fiber comprising:

a first optical fiber having a first core and a first cladding formed around the first core having a cladding outer diameter smaller than 125 μm, wherein the first cladding has a plurality of air holes that extend longitudinally along the axis of the first core;

a second optical fiber having a second core to be spliced to the first core and a second cladding formed around the second core having a cladding outer diameter larger than the outer diameter of the first cladding, wherein the second cladding is to be spliced to the first cladding; and

a fusion splice formed between the end of the first optical fiber and the end of the second optical fiber by fusion, wherein

the end part processing method of the optical fiber is comprised of the steps of

inserting the optical fiber into a fiber insertion hole for inserting the optical fiber formed in a ferrule so that the fusion splice formed between the end of the first optical fiber and the end of the second optical fiber by fusion will be positioned within the ferrule length,

bond-fixing the optical fiber inserted in the fiber insertion hole to the fiber insertion hole by adhesive, and

polishing the end face of the ferrule.

The present invention includes an improvement invention or a modification invention of the end part processing method of an optical fiber by the present invention to solve above-stated problems as described below.

(1) The step of inserting the optical fiber into the fiber insertion hole formed in the ferrule is such a process that the optical fiber is inserted into the fiber insertion hole, into which the adhesive has been injected, from the not-fusion-spliced end of the second optical fiber at an insertion speed such that the adhesive forms a meniscus with the optical fiber at the entrance end of the fiber insertion hole.

(2) The step of inserting the optical fiber into the fiber insertion hole formed in the ferrule is such a process that the optical fiber is inserted into the fiber insertion hole with the ferrule heated.

To solve the above-stated problems, the present invention further provides an optical fiber with ferrule having such a configuration that the optical fiber thereof is inserted in a fiber insertion hole formed in a ferrule to be bond-fixed thereto by adhesive, wherein

the optical fiber is comprised of

a first optical fiber having a first core and a first cladding formed around the first core having a cladding outer diameter smaller than 125 μm, wherein the first cladding has a plurality of air holes that extend longitudinally along the axis of the first core;

a second optical fiber having a second core to be spliced to the first core and a second cladding formed around the second core having a cladding outer diameter larger than the outer diameter of the first cladding, wherein the second cladding is to be spliced to the first cladding; and

a fusion splice formed between the end of the first optical fiber and the end of the second optical fiber by fusion, wherein

the optical fiber is bond-fixed at an as-inserted location such that the optical fiber is inserted in the fiber insertion hole so that the fusion splice formed between the end of the first optical fiber and the end of the second optical fiber by fusion will be positioned within the ferrule length.

The present invention includes an improvement invention or a modification invention of the optical fiber with ferrule by the present invention to solve above-stated problems as described below.

(1) The end face of the second optical fiber located on the opposite side of the fusion splice and the end face of the ferrule lie on one common plane.

The present invention is able to provide an optical fiber that permits, even when the cladding outer diameter thereof is smaller than 125 μm, an eased splicing with other optical fiber using a general-purpose ferrule without relying on such a special ferrule as has an insertion hole for inserting an optical fiber having a reduced inner diameter and a method of manufacturing the same; an end part processing method of an optical fiber; and an optical fiber with a ferrule.

### BRIEF DESCRIPTION OF DRAWINGS

FIG. 1 is a perspective view of an optical fiber in an embodiment of the present invention.

FIG. 2A to FIG. 2C are sectional side views to explain the steps in a method of manufacturing an optical fiber in an embodiment of the present invention.

FIG. 3A and FIG. 3B are sectional side views to explain an end part processing method of an optical fiber in an embodiment of the present invention.

FIG. 4 is a conceptual diagram to illustrate a situation in which a bubble is involved around the optical fiber inserted in a ferrule.

FIG. 5 is a sectional side view to explain an end part processing method of an optical fiber in an embodiment of the present invention.

FIG. 6A and FIG. 6B are sectional side views to illustrate processing aspects at the end of a capillary where the optical fiber is inserted into a ferrule in an end part processing method of an optical fiber in an embodiment of the present invention.

FIG. 7 is a conceptual diagram to illustrate a holey fiber.

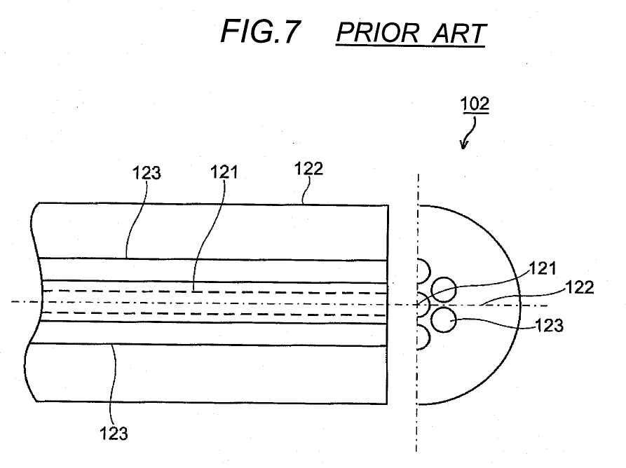

### DETAILED DESCRIPTION OF THE PREFERRED EMBODIMENTS

The following provides a detailed explanation of embodiments of the present invention referring to drawings.

### [Optical Fiber]

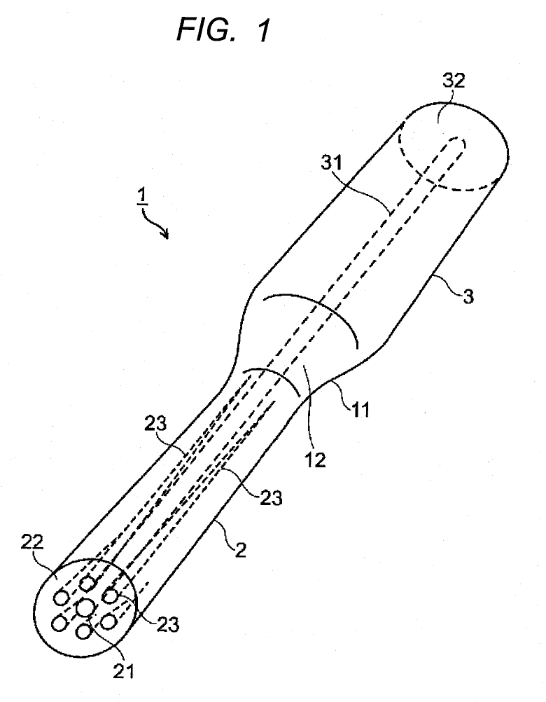

FIG. 1 illustrates an optical fiber in an embodiment of the present invention.

An optical fiber 1 illustrated in FIG. 1 is comprised of

a first optical fiber (a holey fiber) 2 having a first core 21 and a first cladding 22 formed around the first core 21 having a cladding outer diameter smaller than 125 μm, wherein the first cladding 22 has a plurality of air holes 23 that extend longitudinally along the axis of the first core 21; and

a second optical fiber 3 having a second core 31 to be spliced to the first core 21 and a second cladding 32 formed around the second core 31 having a cladding outer diameter larger than the outer diameter of the first cladding 22, wherein the second cladding 32 is to be spliced to the first cladding 22; and

a fusion splice 11 formed between the end of the first optical fiber 2 and the end of the second optical fiber 3 by fusion.

More details follow. The first optical fiber 2 is a holy fiber having such a construction that the first cladding 22 is formed around the first core 21 and that the first cladding 22 has a plurality of air holes 23 that extend longitudinally along the axis of the first core 21. Although the holey fiber 2 illustrated in FIG. 1 has six air holes 23, the number of the air holes in implementing the present invention is not bound to this. In the embodiment, the outer diameter of the first cladding 22 is preferred to be 100 μm or smaller and an appropriate outer diameter is 80 μm±1 μm. The outer diameter of the first core 21 is such an outer diameter as is equivalent to a core outer diameter of a common type of optical fibers.

The second optical fiber 3 is a single-mode fiber comprised of for example the second core 31 and the second cladding 32 formed around the second core 31. In the embodiment, the outer diameter of the second cladding 32 is made equal to 125 μm±1 μm, a generally applied dimension to optical fibers. The outer diameter of the second core 31 is approximately equal to the outer diameter of the first core 21 of the holey fiber 2.

The optical fiber 1 in the embodiment of the present invention is formed by splicing the holey fiber 2 to the single-mode fiber 3 by fusion. In the embodiment, the outer diameter of the first cladding 22 of the holey fiber 2 is 80 μm±1 μm and the outer diameter of the second cladding 32 of the single-mode fiber 3 is 125 μm±1 μm, that is, the outer diameter of the single-mode fiber 3 is larger than that of the holey fiber 2. Therefore, splicing these fibers by fusion makes the fusion splice 11 have a tapered shape in the outer diameter transition, wherein the splice outer diameter gradually reduces from the end of such a portion of the single-mode fiber (the second optical fiber) 3 as has an outer diameter of the second cladding 32 to the end of such a portion of the holey fiber (the first optical fiber) 2 as has an outer diameter of the first cladding 22. The first core 21 of the holey fiber 2 and the second core 31 of the single-mode fiber 3 are optically connected through the fusion splice between the holey fiber 2 and the single-mode fiber 3.

At the fusion splice 11, the first cladding 22 and the second cladding 32 are fused by heat. Therefore, the air holes 23 of the holey fiber 2 are sealed at the portion in the vicinity of the fused splice 11 (at least such an area including the fused splice 11) to establish an air hole seal 12 illustrated in FIG. 1.

### [Method of Manufacturing an Optical Fiber]

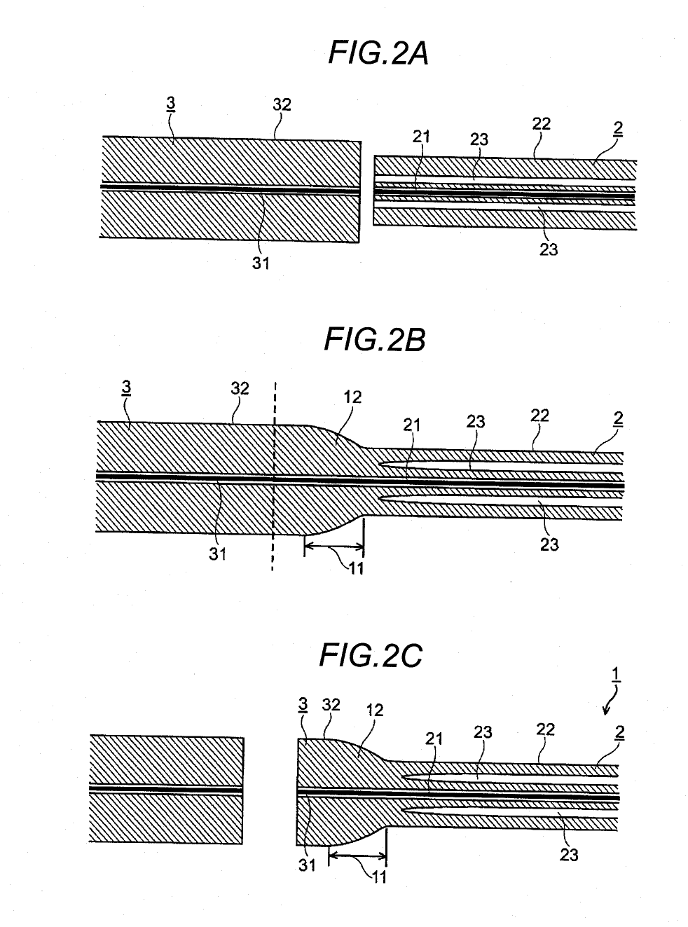

The following explains a method of manufacturing an optical fiber in an embodiment of the present invention referring to FIGS. 2A to 2C. FIG. 2A is a conceptual view that illustrates the holey fiber 2 and the single-mode fiber 3 facing each other on a fusion splicer for the fusion splicing of optical fibers; FIG. 2B is a conceptual view that illustrates the status of optical fibers after fusion splicing; and FIG. 2C is a conceptual view of a state wherein the single-mode fiber 3 has been cut.

As illustrated in FIG. 2A, the holey fiber 2 and the single-mode fiber 3 are arranged on the fusion splicer, which is not shown, so that the ends of each of the fibers will be closely faced each other. When splicing the holey fiber 2 to the single-mode fiber 3 with their end butted in this embodiment, it is preferable to align the optical axes so that the centers of the first core 21 and the second core 31 will be positioned on one common axis relying on defining for example the center of the holey fiber 2 determined by the outer diameter thereof (the point located at a distance of half the outer diameter of the holey fiber 2 from the surface of the first cladding 22) as the center position of the first core 21, and similarly, defining the center of the single-mode fiber 3 determined by the outer diameter of the single-mode fiber 3 as the center position of the second core 31. To do this is because of that the axis aligning based on core profiles as used in the single-mode fiber splicing is not applicable for the reason that the holey fiber 2 does not permit identification of the first core 21 by a visual observation from its lateral side.

There is no particular limitation in the type of the fusion splicer. It is acceptable to use a fusion splicer having aligning function as used in the splicing between multi-mode fibers. Even when a fusion splicer has no aligning function, such a splicer can be made usable merely by equipping the splicer with positioning grooves (V-grooves for example) of different depths each for positioning the holey fiber 2 and the single-mode fiber 3 so that simply placing them on the fusion splicer will align their optical axes.

Thus, the fibers are fusion-spliced in such a manner placing the holey fiber 2 and the single-mode fiber 3 on the fusion splicer with their end faces closely faced; aligning their optical axes, that is, positioning the center of the first core 21 of the holey fiber 2 and the center of the second core 31 of the single-mode fiber 3 to align them on one common axis; and fusion-splicing the fibers applying gaseous discharge with their end faces butted.

FIG. 2B illustrates the state after the end faces of the holey fiber 2 and the single-mode fiber 3 were fusion-spliced. The fusion splice 11 gradually reduces its outer diameter from the outer diameter of the single-mode fiber 3 to the outer diameter of the holey fiber 2; this transition is a smooth-taper variation. In the vicinity of the fusion splice 11, the air holes 23 in the holey fiber 2 are squashed by the fusion-splicing forming the air hole seal 12.

Thus in the embodiment, the fusion-splicing of the holey fiber 2 having air holes 23 to the single-mode fiber 3 provides the air holes 23 with a sealing effect. Thereby, the optical fiber will be enabled to provide enhanced reliability because sealed feature prevents lowering in mechanical strength and fluctuating in optical performance that are attributable to ingress of water into the air holes 23 and condensation therein due to temperature variation.

Even though a slight deviation in axial or angular alignment is involved in the fusion splice in the embodiment, no positional deviation beyond the outer diameter of the single-mode fiber will occur since the outer diameter of the holey fiber 2 is smaller than that of the single-mode fiber 3. Thus, the inserting of the optical fiber 1 into the insertion hole formed in a ferrule for optical fiber connector (an insertion hole of ferrule) does not need using such a ferrule as is made the inner diameter thereof a special dimension, and a general purpose ferrule that has an insertion hole of which inner diameter suits to the outer diameter of the single-mode fiber 3 (125 μm±1 μm for example) is applicable to the insertion of the holey fiber 2 thereinto without touching the inner wall of the insertion hole of the ferrule.

FIG. 2C illustrates a state in which the end faces of the holey fiber 2 and the single-mode fiber 3 are fusion-spliced and thereafter the surplus length of the single-mode fiber 3 has been cut. In the embodiment, the single-mode fiber 3 is given an ample length for workability in the fusion-splicing operation. However, a length other than the lengths for sealing the air holes 23 of the holey fiber and for end part process for splicing to other optical fiber becomes redundant after the splicing; thus, the surplus length of the single-mode fiber 3 is cut thereafter. Thereby, the cutting of the surplus length of the single-mode fiber 3 provides the optical fiber 1 in the embodiment of the present invention. The cutting is applied at the point apart from the fusion splice 11 by a predetermined distance as the dot-dash line in FIG. 2(b) indicates. After the fusion-splicing of the holey fiber 2 to the single-mode fiber 3, the cutting is applied at the specified point.

### [End Part Processing Method of Optical Fiber]

### (1) End Structure of Optical Fiber

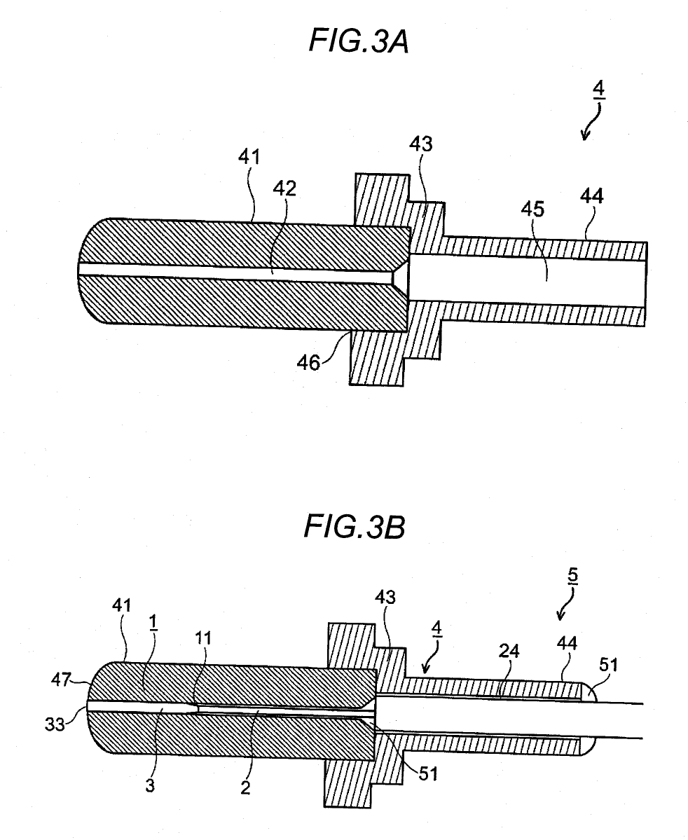

FIG. 3A and FIG. 3B illustrate the end structure of the optical fiber in an embodiment of the present invention. FIG. 3A illustrates the ferrule of an optical connector used in the embodiment and FIG. 3B illustrates the end structure of the optical fiber in the embodiment of the present invention.

A ferrule 4 illustrated in FIG. 3A is a ferrule of ordinary structure generally used in optical connectors. The ferrule 4 is comprised of a capillary 41 and a flange 43 connected to the end of the capillary 41. The capillary 41 has a fiber insertion hole 42 through the entire length of the capillary 41 for inserting the optical fiber. The flange 43 has, as FIG. 3B illustrates, a cylindrical jacketed fiber retaining part 44 for retaining a jacketed optical fiber 24, which is a jacket-applied optical fiber 1, and a capillary retaining part 46 for retaining the capillary 41 with its end connected to the end of the capillary 41. The jacketed fiber retaining part 44 is provided so that it extends in the direction same as the lengthwise of the capillary 41. Penetrating the jacketed fiber retaining part 44 and reaching the capillary retaining part 46, a jacketed fiber insertion hole 45 for inserting the jacketed optical fiber 24 is provided to guide the optical fiber 1 into the fiber insertion hole 42.

Into the capillary retaining part 46, the capillary 41 is inserted and fitted to comprise the ferrule 4. In this configuration, the centerlines of the fiber insertion hole 42 and the jacketed fiber insertion hole 45 are approximately aligned on one common line.

FIG. 3B illustrates the end structure of the optical fiber and an optical fiber with ferrule in the embodiment of the present invention. An optical fiber end 5 illustrated in FIG. 3B is comprised of the ferrule 4 and the optical fiber 1. The optical fiber 1 in the figure is in a state wherein the single-mode fiber 3 is fusion-spliced to the end of the holey fiber 2 and the surplus length of the single-mode fiber 3 has been cut.

At the optical fiber end 5, the ferrule 4 is in such a state that the capillary 41 is inserted and fitted into the capillary retaining part 46. The optical fiber 1, which is comprised of the holey fiber 2 and the single-mode fiber 3 fusion-spliced thereto, is inserted into the fiber insertion hole 42 of the capillary 41. The jacketed optical fiber 24 is retained by the jacketed fiber insertion hole 45 of the jacketed fiber retaining part 44. The spaces between the constituents of the optical fiber 1, the single-mode fiber 3 and the holey finer 2 and the fiber insertion hole 42, and between the jacketed optical fiber 24 and the jacketed fiber insertion hole 45, are filled with an adhesive 51 to hold the optical fiber 1 in the ferrule 4.

The end face of the capillary 41 on the single-mode fiber 3 side is polished after the adhesive 51 for holding in the ferrule 4 has cured. Polishing the end face of the capillary 41 forms a polished face 47 on the capillary 41 causing the end face of the single-mode fiber 3 to expose on the polished face 47 of the capillary 41 forming an exposed end 33. The exposed end 33 enables the optical fiber end 5 in the embodiment of the present invention to be spliced to other optical fiber. In a usual practice, a connector housing is installed over the ferrule so as to envelope the ferrule configuring a connector plug to permit mating to another connector plug helped by a connector adapter. Thus, the optical fiber with ferrule in the embodiment of the present invention, in which the end face of the optical fiber 1 and the end face of the ferrule 4 are on one common plane, is obtained.

### (2) End Part Processing Method of an Optical Fiber

The processing method of the optical fiber end 5 illustrated in FIG. 3B is the same as that in the practice for installation of a ferrule on a typical optical fiber.

That is, the adhesive 51 is injected into the jacketed fiber insertion hole 45 from the end face of the jacketed fiber retaining part 44 of the ferrule 4 illustrated in FIG. 3A. As for the adhesive 51, it is preferable to use a thermosetting type adhesive such as epoxy series resin. After that, the optical fiber 1 is inserted from the end of the single-mode fiber 3 entering the end face of the jacketed fiber retaining part 44 with a push given toward the capillary 41. The single-mode fiber 3 is brought until its end projects from the end face of the capillary 41 passing through the jacketed fiber insertion hole 45 and penetrating the fiber insertion hole 42.

When the end of the single-mode fiber 3 projects from the end face of the capillary 41, the optical fiber end 5 is heated to cause the adhesive 51 to cure. The adhesive 51 injected in the jacketed fiber insertion hole 45 has spread over the whole area of the jacketed fiber insertion hole 45 and the fiber insertion hole 42 along with the insertion of the optical fiber 1. Therefore, heating the optical fiber end 5 causes the adhesive 51 make the optical fiber 1 and the jacketed optical fiber 24 inside the ferrule 4 be firmly fixed to, and held on, the inner walls of the jacketed fiber insertion hole 45 and the fiber insertion hole 42.

After the adhesive 51 has cured, the end face of the capillary 41 is polished over the area covering the end face of the single-mode fiber 3 to form the polished face 47. Thereby, the polished face of the single-mode fiber 3 exposes on the end face of the capillary 41.

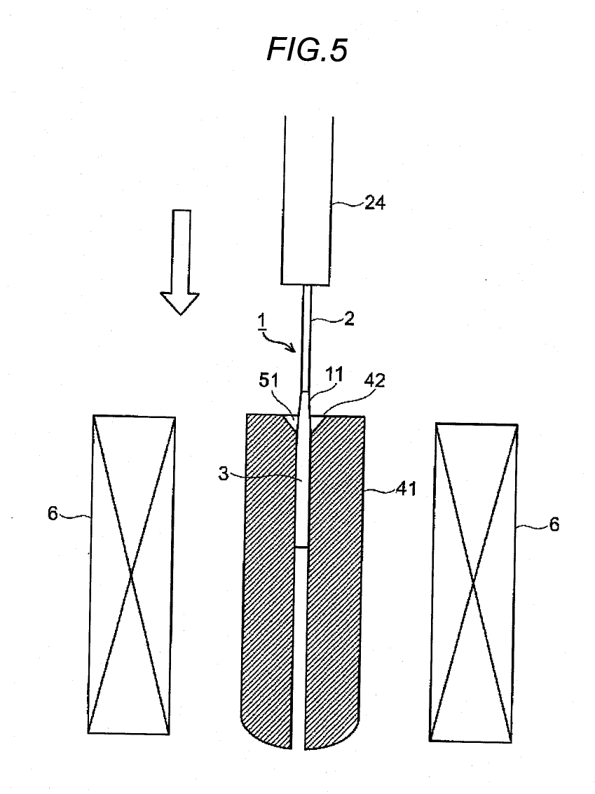

FIG. 5 illustrates a processing aspect in an end part processing method of an optical fiber in an embodiment of the present invention. In the embodiment, the ferrule is held upright so that the flange side thereof comes up. In FIG. 5, the flange part is omitted from the figure for simplicity in explanation and only the capillary 41 of the ferrule is illustrated.

A proper amount of the epoxy series thermosetting type adhesive 51 is injected into the fiber insertion hole 42 (and the jacketed fiber insertion hole) of the capillary 41 held upright. And then, the optical fiber 1 is inserted from the single-mode fiber 3 side downwardly from the upper side of the setup slowly into the fiber insertion hole 42 (and the jacketed fiber insertion hole) in the direction that the arrow in FIG. 5 indicates. In this insertion process, it is more favorable to heat the capillary 41 (ferrule) by a heating means such as a heater 6, 6 provided around the capillary 41.

When processing in a manner as stated above in the embodiment, the fusion splice 11 tends to involve a bubble on insertion of the optical fiber 1 in its taper-shaped section since the fusion splice 11, a splice formed between the holey fiber 2 and the single-mode fiber 3, has a tapered shape.

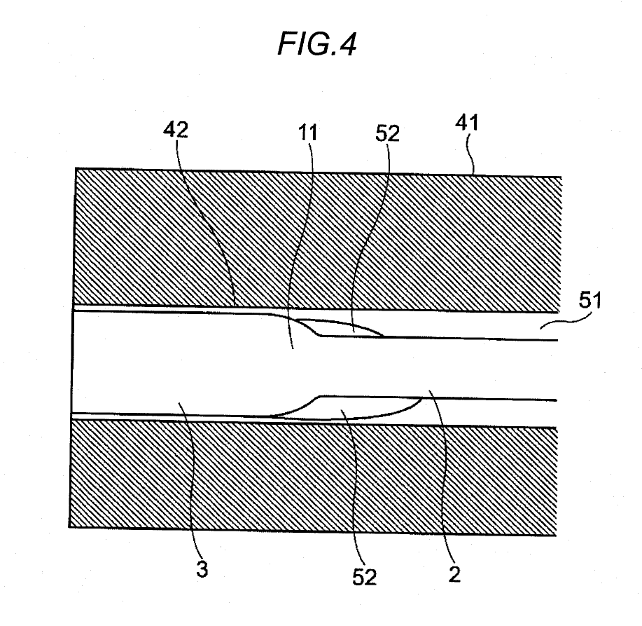

FIG. 4 illustrates a situation in which a bubble is involved in the taper-shaped section of the fusion splice 11. As illustrated in FIG. 4, the single-mode fiber 3 and the holey fiber 2 are inserted in the fiber insertion hole 42 of the capillary 41 and the spaces between the inner wall of the fiber insertion hole 42 and the single-mode fiber 3 and the holey fiber 2 are filled with the adhesive 51. In this state, the taper-shaped section of the fusion splice 11, a splice formed between the single-mode fiber 3 and the holey fiber 2, tends to involve bubbles 52, 52.

When bubbles 52, 52 have been involved as illustrated in FIG. 4, heating for curing the adhesive 51 causes the bubbles 52, 52 to make for tendency toward expansion. This may cause a severe stress in the single-mode fiber 3 or in the holey fiber 2 possibly resulting in break of the optical fiber. Even if the breakage of the optical fiber does not occur at the time of heating, this will increase the possibility of developing into breakage in the longer term. Further, this gives the optical fiber a minute bend inviting a problem in that the transmission properties will easily fluctuate.

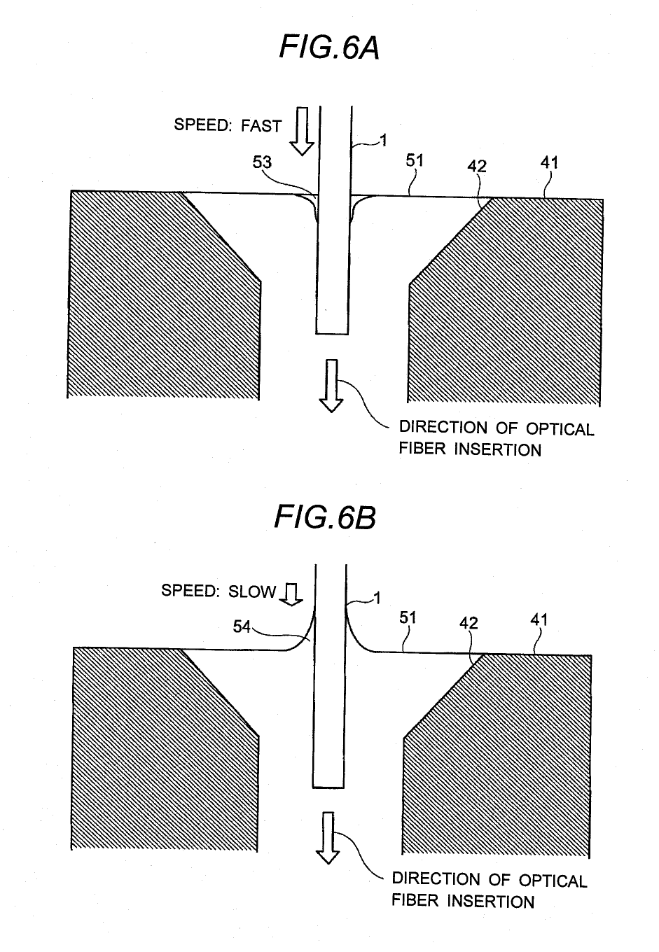

FIG. 6A and FIG. 6B provide a rough indication for a proper insertion speed of the optical fiber. FIG. 6A illustrates a case where the insertion speed of the optical fiber is too fast and FIG. 6B a case the speed proper.

Where the insertion speed of the optical fiber is too fast as FIG. 6A illustrates, the adhesive 51 is dragged by the movement of the surface of the optical fiber (in FIG. 6A, the surface of the single-mode fiber 3) due to its viscosity causing the liquid level to be lowered resulting in forming a liquid level subsidence 53. Under this condition, bubbles are easily involved because it is not an easy behavior for the adhesive 51 to follow promptly the transition along the fusion splice 11 on the optical fiber in the embodiment toward smaller outer diameter.

Where the insertion speed of the optical fiber is proper as FIG. 6B illustrates, the adhesive 51 forms a meniscus 54 on its surface of contact with the optical fiber because movement of the adhesive 51 by the surface tension is dominant in such area. Under this condition, the bubble involvement becomes hard to occur because the adhesive 51 wets the surface of the optical fiber ahead.

The insertion speed should be determined so that the situation will be as illustrated in FIG. 6B, avoiding such a state as is illustrated in FIG. 6A. That is, the optical fiber should be inserted into the fiber insertion hole 42 at such a speed that the adhesive 51 maintains the meniscus 54 with the optical fiber.

It is preferable to use a device that enables a linear motion because a manual control of insertion speed in this operation is difficult. When an operation in an increased speed is desired, heating the ferrule by such as the heater 6 as illustrated in FIG. 5 is effective since warmed adhesive 51 lowers its viscosity.

In the optical fiber end part thus obtained in the embodiment, even the holey fiber 2, of which outer diameter is thin, is covered closely with the adhesive 51 without empty space; therefore, no problems will occur in reliability. Further, because of that the jacketed optical fiber 24, the jacketed part of the holey fiber 2, is fixed in the jacketed fiber insertion hole 45 by the same adhesive as used for the holey fiber 2, tension or torsion on the jacketed optical fiber 24, if applied, will be hardly transmitted to the holey fiber 2.

### Modification Example of Present Invention

As for the adhesive to be used in the embodiment, it is preferable to use a thermosetting resin of low viscosity or such an instant adhesive as is applicable to installing ferrules (Trade product code: AT8816; NTT Advanced Technology Corp.) to prevent involving bubbles inside the ferrule.

In the embodiment, the explanation has taken a ferrule for a single-fiber connector as an explanatory example; it is also feasible to apply the invention to multi-fiber ferrules such as for MT connectors and MPO connectors. However, when an aligning type fusion splicer is used, it is preferable to make fusion splice separately for each of optical fibers one by one.

### Effect of Embodiments

In the embodiments stated above, the optical fiber has such a configuration that the end of a holey fiber having an outer diameter smaller than 125 μm is fusion-spliced to a single-mode fiber having an outer diameter larger than the holey fiber. Therefore, a general-purpose ferrule for single-mode fibers can be used in splicing the optical fiber to other fiber.

Further in the embodiment stated above, a general-purpose ferrule having a fiber insertion hole of such an inner diameter as is compatible with a single-mode fiber is applicable to a holey fiber having an outer diameter smaller than 125 μm. Therefore, even when splicing a very thin holey fiber for special use having an outer diameter smaller than 80 μm to other optical fiber, providing only a single-mode fiber permits an eased splicing to other optical fiber without using a special ferrule.

The embodiment is also applicable to a use other than the optical connector. For example, when connection with an optical waveguide or coupling between a light emitting element and a light receiving element intends to establish such linkage using a holey fiber having an outer diameter smaller than 125 μm, it is enough to fusion-splice a single-mode fiber of common type to the end of the holey fiber followed by fixing the single-mode fiber portion thereof on the V-groove of a specified part according to the conventional practice.

If ends of air holes in the cladding of the holey fiber are left open, water ingress into the air holes and condensation therein attributable to the temperature variation will occur, and therefrom lowering in the mechanical strength or fluctuation of optical properties may be resulted. As a preventive measure against such problem, known conventional practice includes sealing the air holes injecting a adhesive from the end face, squashing the air holes by heating from the circumference of the cladding at the position slightly apart from the end face, and sealing the air holes by heating applied to the end face from the position opposite to the end face using the fusion splicer (an apparatus for splicing optical fibers by fusion heated by gaseous discharge). However, they involve problems. Sealing by the adhesive requires an extreme caution in selection of the adhesive, its quality control, its sealing operation, etc. since the adhesive has a concern about aging deterioration. Fusing the optical fiber itself by heat requires fiber-cutting operation to make the fused portion neat as the connection end face because the fused portion is local although this practice is advantageous in that there is no concern about aging deterioration unlike the adhesive and end polishing is easy.

In contrast in the embodiment, the sealing of the air holes is established by the second optical fiber since the end of the second optical fiber is fusion-spliced to the first optical fiber. Therefore, no problems occur in terms of above-stated problems permitting the splicing to other optical fiber to be eased.

1. An optical fiber comprising:
a first optical fiber having a first core and a first cladding formed around said first core having a cladding outer diameter smaller than 125 μm, wherein said first cladding has a plurality of air holes that extend longitudinally along the axis of said first core;
a second optical fiber having a second core to be spliced to said first core and a second cladding formed around said second core having a cladding outer diameter larger than the outer diameter of said first cladding, wherein said second cladding is to be spliced to said first cladding; and
a fusion splice formed between the end of said first optical fiber and the end of said second optical fiber by fusion.

2. The optical fiber according to claim 1, wherein said fusion splice has a tapered shape in the outer diameter transition, wherein the outer diameter of said fusion splice gradually reduces from said second optical fiber to said first optical fiber.

3. The optical fiber according to claim 1, wherein the outer diameter of said first cladding of said first optical fiber is 100 μm or smaller and the outer diameter of said second cladding of said second optical fiber is 125±1 μm.

4. The optical fiber according to claim 1, wherein a plurality of air holes are sealed at said fusion splice with said second optical fiber.

5. A method of manufacturing an optical fiber having such a configuration that
the end of a first optical fiber having a first core and a first cladding formed around said first core having a cladding outer diameter smaller than 125 μm, wherein said first cladding has a plurality of air holes that extends longitudinally along the axis of said first core, is spliced to
the end of a second optical fiber having a second core to be spliced to said first core and a second cladding formed around said second core having a cladding outer diameter larger than the outer diameter of said first cladding, wherein said second cladding is to be spliced to said first cladding, wherein
said method of manufacturing said optical fiber is comprised of the steps of
butting ends of said first optical fiber and said second optical fiber aligning optical axes of said first core and said second core; and
splicing by fusing the butted ends of said first optical fiber and said second optical fiber to form a fusion splice.

6. The method of manufacturing an optical fiber according to claim 5, wherein said step of butting ends of said first optical fiber and said second optical fiber is such a process that the optical axes of said first core and said second core are aligned by positioning said first optical fiber and said second optical fiber so that the center of said first core determined by the position of the diametrical profile of said first cladding and the center of said second core determined by the position of the diametrical profile of said second cladding will align on one common axis.

7. The method of manufacturing an optical fiber according to claim 5, wherein said step of splicing by fusing the butted ends of said first optical fiber and said second optical fiber to form a fusion splice is such a process that said fusion splice is formed so that the fused splice thereon will have a tapered shape in terms of the outer diameter, wherein the outer diameter of said fusion splice gradually reduces to said first optical fiber from said second optical fiber.

8. The method of manufacturing an optical fiber according to claim 5, wherein said step of splicing by fusing the butted ends of said first optical fiber and said second optical fiber to form a fusion splice is such a process that said splice is formed so that the plurality of air holes will be sealed by said second optical fiber at said fusion splice.

9. An end part processing method of an optical fiber, said optical fiber as defined in claim 1, wherein said end part processing method of said optical fiber is comprised of the steps of inserting said optical fiber into a fiber insertion hole for inserting said optical fiber formed in a ferrule so that said fusion splice formed between the end of said first optical fiber and the end of said second optical fiber by fusion will be positioned within said ferrule length, bond-fixing said optical fiber inserted in said fiber insertion hole to said fiber insertion hole by adhesive, and polishing the end face of said ferrule.

10. The end part processing method of an optical fiber according to claim 9, wherein said step of inserting said optical fiber into said fiber insertion hole formed in said ferrule is such a process that said optical fiber is inserted into said fiber insertion hole, into which said adhesive has been injected, from the not-fusion-spliced end of said second optical fiber at an insertion speed such that said adhesive forms a meniscus with said optical fiber at the entrance end of said fiber insertion hole.

11. The end part processing method of an optical fiber according to claim 9, wherein said step of inserting said optical fiber into said fiber insertion hole formed in said ferrule is such a process that said optical fiber is inserted into said fiber insertion hole with said ferrule heated.

12. An optical fiber with ferrule having such a configuration that said optical fiber thereof is inserted in a fiber insertion hole formed in a ferrule to be bond-fixed thereto by adhesive, wherein said optical fiber is comprised of
a first optical fiber having a first core and a first cladding formed around said first core having a cladding outer diameter smaller than 125 μm, wherein said first cladding has a plurality of air holes that extend longitudinally along the axis of said first core;
a second optical fiber having a second core to be spliced to said first core and a second cladding formed around said second core having a cladding outer diameter larger than the outer diameter of said first cladding, wherein said second cladding is to be spliced to said first cladding; and
a fusion splice formed between the end of said first optical fiber and the end of said second optical fiber by fusion, wherein
said optical fiber is bond-fixed at an as-inserted location such that said optical fiber is inserted in said fiber insertion hole so that said fusion splice formed between the end of said first optical fiber and the end of said second optical fiber by fusion will be positioned within said ferrule length.

13. The optical fiber with ferrule according to claim 12, wherein the end face of said second optical fiber located on the opposite side of said fusion splice and the end face of said ferrule lie on one common plane.
